(19) United States
(12) Patent Application Publication
(10) Pub. No.: US 2026/0113646 A1
(43) Pub. Date: Apr. 23, 2026

(54) DYNAMIC METHODS FOR ROBUST DETECTION OF SYSTEM ANOMALOUS SOURCES

(71) Applicant: T-Mobile USA, Inc., Bellevue, WA (US)

(72) Inventor: Yousef Alabssi, Parsippany, NJ (US)

(21) Appl. No.: 18/919,360

(22) Filed: Oct. 17, 2024

(51) Int. Cl. H04W 24/08; H04W 24/10

(52) U.S. Cl. CPC H04W 24/08; H04W 24/10

(57) ABSTRACT

A system and methods are disclosed comprising techniques for anomaly detection and management. The techniques can include receiving a set of call data records (CDRs) from one or more network monitoring sources, identifying an anomalous performance signal indicating erroneous activity within one or more network components of a telecommunications network, generating a signal profile for the identified anomalous performance signal comprising a set of target network attributes, selecting a first target network component deployed within a runtime environment of the telecommunications network, deploying a self-executing troubleshoot agent configured to evaluate compliance of the first target network component with a first set of KPIs during runtime, generating an anomalous performance report comprising an actionable narrative for the identified anomalous performance signal based on at least one failed KPI of the first target network component, and transmitting the generated anomalous performance report for display at a subscribing user interface.

### BACKGROUND

Corrective and preventive action (CAPA) consists of improvements to organizational processes made to eliminate causes of non-conformities or other undesirable situations. CAPA is usually a set of actions, laws, or regulations with which an organization is required to comply in manufacturing, documentation, procedures, or systems to rectify and eliminate recurring non-conformance. Non-conformance is identified after systematic evaluation and analysis of the root cause of the non-conformance. Non-conformance may be a market complaint, a customer complaint, a failure of machinery or a quality management system, or a misinterpretation of written instructions to carry out work. The CAPA is designed by a team that includes quality assurance personnel and personnel involved in the actual observation point of non-conformance. It must be systematically implemented and observed for its ability to eliminate further recurrence of such non-conformance.

CAPA is used to bring about improvements to organizational processes and is often undertaken to eliminate causes of non-conformities or other undesirable situations. CAPA is a concept within good manufacturing practice (GMP), Hazard Analysis and Critical Control Points/Hazard Analysis and Risk-based Preventive Controls (HACCP/HARPC), and numerous ISO business standards. It focuses on the systematic investigation of the root causes of identified problems or identified risks in an attempt to prevent their recurrence (for corrective action) or to prevent occurrence (for preventive action).

Corrective actions are implemented in response to customer complaints, unacceptable levels of product non-conformance, or issues identified during an internal audit, as well as in response to adverse or unstable trends in product and process monitoring such as would be identified by statistical process control (SPC). Preventive actions are implemented in response to the identification of potential sources of non-conformity.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates an anomaly management system that can implement aspects of the present technology.

FIG. 3 is a block diagram that illustrates an example signal characterization process of an anomaly management system, in accordance with some implementations of the present technology.

FIG. 4 is a block diagram that illustrates an example investigation process of an anomaly management system, in accordance with some implementations of the present technology.

FIG. 5 is a block diagram that illustrates an example feedback process of an anomaly management system, in accordance with some implementations of the present technology.

FIG. 6 is a flow diagram that illustrates a process to evaluate anomalous performance signals in some implementations.

FIG. 7 is a block diagram of an example transformer that can implement aspects of the present technology.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Existing systems typically rely on a manual vetting process (e.g., performed by a human analyst) to recognize anomalous performance metrics (e.g., outlier network traffic data) of a computing system (e.g., a telecommunications network), determine relevant computing services (e.g., network components), identify the specific cause (e.g., an erroneous software) of the anomalous metrics, and execute a remediation strategy (e.g., an updated software version). Manually identifying and responding to anomalous performance signals is a time-intensive process that often requires several hours, or days, to complete. Accordingly, existing systems are typically slow and inefficient at addressing time-sensitive tasks for maintaining reliable computing systems. To further compound the issue, large and distributed computing infrastructures (e.g., telecommunications networks) often rely on complex and frequently changing combinations of dependent services (e.g., software versions, hardware components, third-party services, and/or the like) that naturally require additional time for manual analysis and remediation. As a result, these and other problems associated with inefficient manual detection of and response to anomalous performance metrics of telecommunications network systems can significantly diminish the overall user experience (e.g., via erroneous service features), place undue burden on maintenance support teams, negatively impact service providers and third-party services, and so forth.

Disclosed herein are a system and related methods for identifying and managing sources of anomalous signals (e.g., outlier network traffic data) of a computing system (e.g., a telecommunications network). The disclosed system can determine erroneous computing components (e.g., network services and/or nodes) via deployment of self-executing troubleshoot agents (e.g., automated software programs) that evaluate system compliance with key performance indicators (KPIs) (e.g., expected network data transfer and/or traffic flow). By dynamically profiling erroneous performance metrics, the disclosed system enables subscribing users (e.g., network service developers) to efficiently deploy remediation strategies for the computing system.

The disclosed system can identify anomalous network performance signals associated with runtime processes of a telecommunications network. As an illustrative example, the disclosed system uses statistical inferencing tools (e.g., unsupervised learning algorithms, machine learning models, and/or the like) to find outlier traffic data from call data records (CDRs) of real-time network services. The system further generates a unique profile (e.g., an identifiable set of characteristics) for detected anomalous signals of the telecommunications network. In particular, the system can assemble a composite data structure (e.g., a JSON object) comprising identifiable network attributes that associates an anomalous signal to a group, or subgroup, of network components. As a result, the system enables subscribing users (e.g., via automated executable programs) to efficiently identify relevant network components (e.g., network nodes, locations, and/or services) for a detected anomalous signal.

In some aspects, the disclosed system can deploy self-executing troubleshoot agents for identifying potential computing sources (e.g., erroneous network components) of detected anomalous signals. For example, the system can use the unique signal profiles of the detected anomalous signal to identify relevant network components (e.g., potential erroneous nodes) of the telecommunications network. Accordingly, the system can furthergenerate, and deploy, an automated executable program that is configured to perform one or more troubleshoot operations (e.g., scanning for erroneous features, testing performance compliance, and/or the like) on the identified network components.

Advantages of the disclosed system include a robust characterization process for anomalous performance signals of runtime computing services (e.g., network components), such as by leveraging statistical inference algorithms to identify relevant network attributes. As a result, the disclosed technology can dynamically adapt to design and/or implementation changes propagated for the telecommunications network, resulting in reduced manual labor costs. Furthermore, the disclosed technology can intelligently deploy automatic evaluation programs that assess performance compliance of select network components with high relevance to the detected anomalous signals.

For illustrative purposes, some examples of systems and methods are described herein in the context of anomaly management systems for a telecommunications network. However, a person skilled in the art will appreciate that the disclosed system can be applied in other contexts. As an example, the disclosed system can be used within distributed computing systems to dynamically identify potential computing sources (e.g., hardware and/or software causes) of anomalous performance results (e.g., non-compliance with expected thresholds, erroneous computing features, and/or the like).

The operation to generate, and deploy, automatic troubleshoot agents (e.g., via generative machine learning models) for evaluating performance compliance of computing components (e.g., network services) as disclosed herein causes a reduction in greenhouse gas emissions compared to conventional methods of manual anomaly detection and management. Every year, approximately 40 billion tons of carbon dioxide are emitted around the world. Power consumption by digital technologies, including computing systems of telecommunications networks, accounts for approximately 4% of this figure. Further, extended use of computing resources by maintenance support teams for manually identifying anomalous performance signals exacerbates the causes of climate change. For example, the average U.S. power plant expends approximately 600 grams of carbon dioxide for every kilowatt-hour generated. The implementations disclosed herein for automatic generation and deployment of self-executing troubleshoot agents can mitigate climate change by reducing and/or preventing additional greenhouse gas emissions into the atmosphere. For example, automating detection and management of anomalous computing performance as described herein significantly reduces processing time, and subsequently electrical power consumption, of network systems. By reducing manual analysis time, the disclosed system provides increased energy and computational resource efficiency compared to traditional methods.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

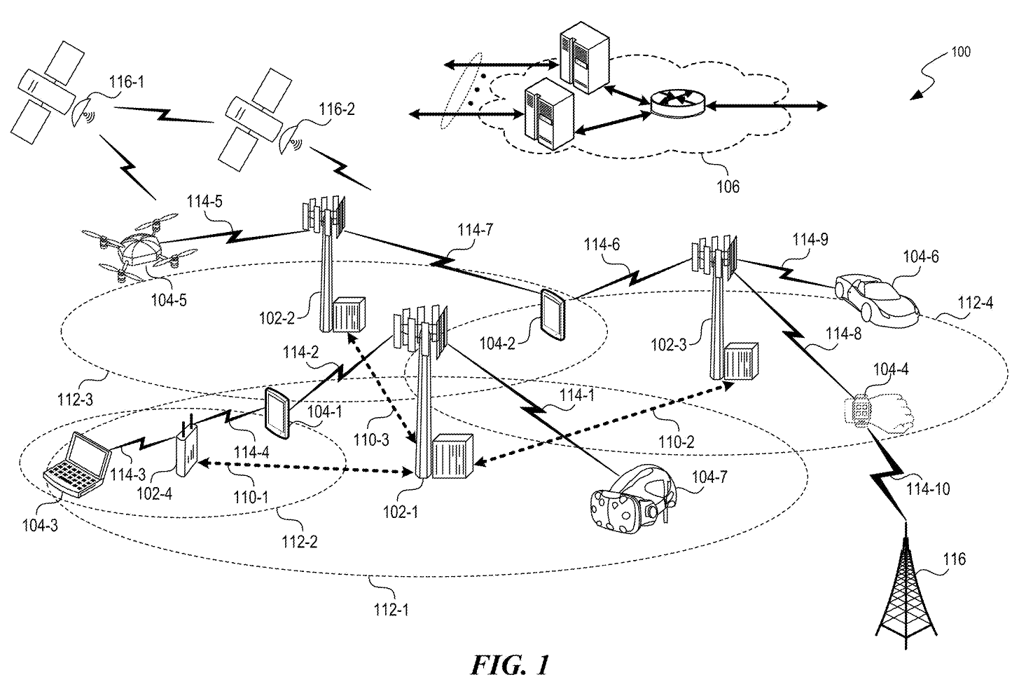

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Anomaly Management System

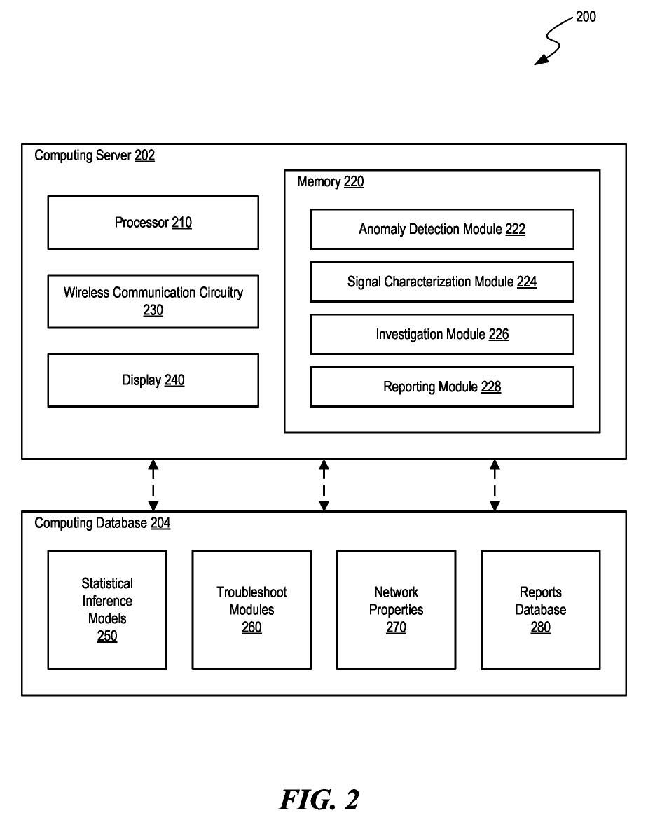

FIG. 2 is a block diagram that illustrates an anomaly management system 200 (“system 200”) that can implement aspects of the present technology. The components shown in FIG. 2 are merely illustrative, and well-known components are omitted for brevity. As shown, the computing server 202 includes a processor 210, a memory 220, a wireless communication circuitry 230 to establish wireless communication and/or information channels (e.g., Wi-Fi, internet, APIs, communication standards) with other computing devices and/or services (e.g., servers, databases, cloud infrastructure), and a display 240 (e.g., user interface). The processor 210 can have generic characteristics similar to general-purpose processors, or the processor 210 can be an application-specific integrated circuit (ASIC) that provides arithmetic and control functions to the computing server 202. While not shown, the processor 210 can include a dedicated cache memory. The processor 210 can be coupled to all components of the computing server 202, either directly or indirectly, for data communication. Further, the processor 210 of the computing server 202 can be communicatively coupled to a computing database 204 that is hosted alongside the computing server 202 on the core network 106 described in reference to FIG. 1. As shown, the computing database 204 can include memory partitions, or individual component database hardware, comprising statistical inference models 250, troubleshoot modules 260, network properties 270, and a reports database 280.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional, or alternative, embodiments, the processor 210 can store temporary information onto the memory 220 and store long-term data onto the computing database 204. The memory 220 is merely an abstract representation of a storage environment. Hence, in some embodiments, the memory 220 comprises one or more actual memory chips or modules.

As shown in FIG. 2, modules of the memory 220 can include an anomaly detection module 222, a signal characterization module 224, an investigation module 226, and a reporting module 228. Other implementations of the computing server 202 include additional, fewer, or different modules, or distribute functionality differently between the modules. As used herein, the term “module” refers broadly to software components, firmware components, and/or hardware components. Accordingly, the modules 222, 224, 226, 228 could each comprise software, firmware, and/or hardware components implemented in, or accessible to, the computing server 202.

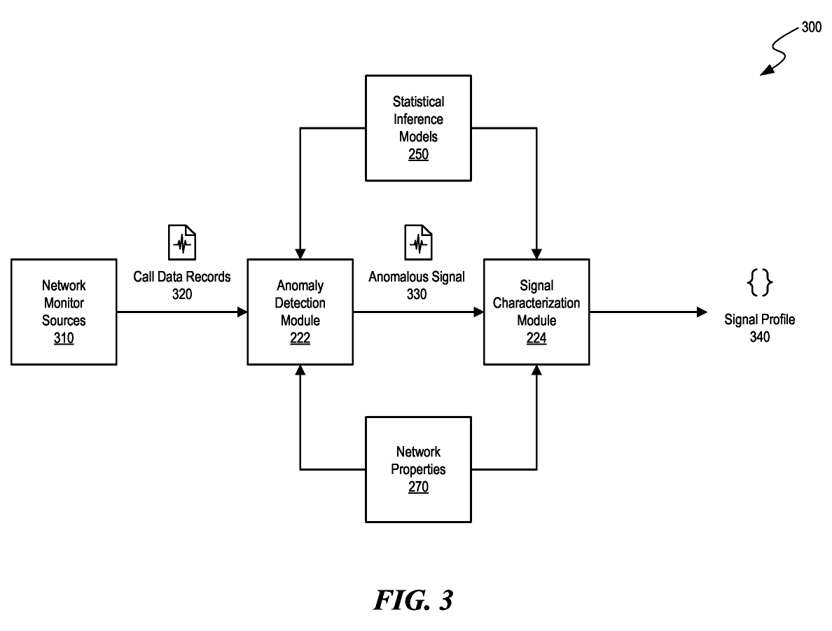

FIG. 3 is a block diagram that illustrates an example signal characterization process 300 of an anomaly management system, in accordance with some implementations of the present technology. The process 300 can be performed by a system (e.g., an anomaly management system 200) configured to generate a signal profile 340 comprising a set of identifiable network characteristics associated with a detected anomalous signal. In one example, the system includes at least one hardware processor and at least one non-transitory memory storing instructions, which, when executed by the at least one hardware processor, cause the system to perform the process 300. In another example, the system includes a non-transitory, computer-readable storage medium comprising instructions recorded thereon, which, when executed by at least one data processor, cause the system to perform the process 300.

As shown in FIG. 3, the system comprises an anomaly detection module 222 configured to identify anomalous network performance signals 330 (“anomalous signals 330”) associated with runtime processes of a telecommunications network. For example, the anomaly detection module 222 can receive a set of call data records (CDRs) 320 for the telecommunications network. A received CDR 320 comprises quantitative metrics that measure runtime performance (e.g., real-time traffic data) of component computing services of the telecommunications network, including voice traffic (e.g., Voice over Internet Protocol (VoIP), Public Switched Telephone Network (PSTN), and/or the like), video traffic (e.g., video conferences, video streams, broadcasts, and/or the like), and/or data traffic (e.g., Transmission Control Protocol (TCP), Internet Protocol (IP), User Datagram Protocol (UDP), HyperText Transfer Protocol/Secure (HTTP/HTTPS), File Transfer Protocol (FTP), Simple Mail Transfer Protocol (SMTP), Internet Message Access Protocol (IMAP), Post Office Protocol 3 (POP3), and/or the like). In some implementations, the received CDR 320 can comprise a set of identifiable attributes corresponding to individual network components of the telecommunications network, such as a cause code, a reason header, a Type Allocation Code (TAC), a Telephony Application Server (TAS) node, a Call Session Control Function (CSCF) node, a Mobile Terminated (MT) number analysis identifier, a market identifier, a region identifier, a pool identifier, a vendor identifier, and/or a technology category. In further implementations, the network properties 270 component of the computing database 204 can comprise a mapping between the set of identifiable network attributes and network components of the telecommunications network. Accordingly, the system (e.g., via the anomaly detection module 222) can use the set of identifiable network attributes to determine network components that correspond, at least in part, to the generation of one or more of the quantitative metrics measuring runtime performance of the telecommunications network.

The anomaly detection module 222 receives CDRs 320 from one or more network monitor sources 310 of the telecommunications network. The system can deploy a network monitor source 310 as a computing process configured to collect, and transmit, unstructured (e.g., unprocessed) traffic data of one or more components of the telecommunications network. In some implementations, the system can deploy the network monitor source 310 as a continuous background process (e.g., a listener daemon) for monitoring network traffic and/or data transfers. In other implementations, the system can configure the network monitor source 310 to collect network traffic data from data surveillance tools (e.g., Splunk, OpenSearch, Grafana, NetScout, Prometheus, and/or the like) associated with network components (e.g., via an API, a webhook, an internet connection, and/or the like). Accordingly, the anomaly detection module 222 can be configured to stream network traffic data for the one or more network components from the network monitor source 310 at a periodic frequency (e.g., once a day, once an hour, once a minute, and/or the like). In additional or alternative implementations, the anomaly detection module 222 can accumulate network data received from the network monitor sources 310 for a specified period prior to further data processing.

The anomaly detection module 222 can be further configured to standardize data received from CDRs 320 of the telecommunications network. For example, the anomaly detection module 222 can stream unprocessed network data directly from one or more network monitor sources 310 that comprise incompatible data structures (e.g., inconsistent data organization methods, misaligned capture periods, and/or the like). As a result, the anomaly detection module 222 can parse the unprocessed network data (e.g., custom JSON objects) into a processed format (e.g., tabular CSV) to standardize received network traffic data. In some implementations, the anomaly detection module 222 can apply additional data processing methods (e.g., normalization, iterative naming schema, and/or the like) to further standardize the network traffic data of the processed format. In other implementations, the anomaly detection module 222 can directly incorporate results from data surveillance tools that pre-arrange network traffic data in a processed format.

The anomaly detection module 222 can use the real-time network traffic data received from network monitor sources 310 to determine anomalous signals 330 of a telecommunications network. For example, the anomaly detection module 222 can apply statistical inference models 250 (e.g., local outlier factor (LOF) algorithms, machine learning models, and/or the like) onto standardized network traffic data of CDRs 320 to identify anomalous signals 330 that exceed a tolerance threshold (e.g., an outlier threshold). In some implementations, the anomaly detection module 222 can use an identified anomalous signal 330, and the corresponding CDR 320 information, to create a new data sample for updating (e.g., training, fine-tuning, and/or the like) the statistical inference methods. As an illustrative example, the anomaly detection module 222 can use an identified anomalous signal 330 for high frequency network traffic data, such as VoIP, to fine-tune unsupervised LOF learning algorithms.

As shown in FIG. 3, the system comprises a signal characterization module 224 configured to generate a signal profile 340 for detected anomalous signals 330. For example, the signal characterization module 224 can assemble a composite data structure (e.g., a JSON object, a tabular CSV, and/or the like) comprising identifiable network attributes (e.g., a subset of attributes from received CDRs) that associates an anomalous signal 330 identified by the anomaly detection module 222 to a group, or subgroup, of network components. Accordingly, the signal profile 340 represents a unique identifier for a set of network components that are potential sources for the anomalous signal 330, thereby reducing the overall search dimensionality for the telecommunications network. As a result, the signal characterization module 224 generates a signal profile 340 that enables other computing components and/or processes of the anomaly management system to efficiently identify relevant network components (e.g., network nodes, locations, and/or services) for a detected anomalous signal 330.

In some implementations, the signal characterization module 224 can generate a signal profile 340 for detected anomalous signals 330 using statistical inference methods. For example, the signal characterization module 224 can apply statistical inference models 250 (e.g., unsupervised LOF algorithms, machine learning models, and/or the like) to identify network attributes from received CDRs 320 that are relevant to a detected anomalous signal 330. In further implementations, the signal characterization module 224 can incorporate additional metadata information associated with the identified network attributes to the signal profile 340. For example, the signal characterization module 224 can embed additional mappings between identifiable network attributes and network components (e.g., links between network hosted services and routers, data centers, Mobility Management Entities (MMEs), Session Management Functions (SMFs), and/or the like) from one or more domain specific rule sets associated with the telecommunications network. In another example, the signal characterization module 224 can embed dynamic topological graphs (e.g., frequently updated architectural mappings) comprising relational information (e.g., hierarchical, dependency, and/or the like) for interconnected network components of the telecommunications network. In additional or alternative implementations, the signal characterization module 224 can retrieve the additional metadata information from the network properties 270 of the computing database 204.

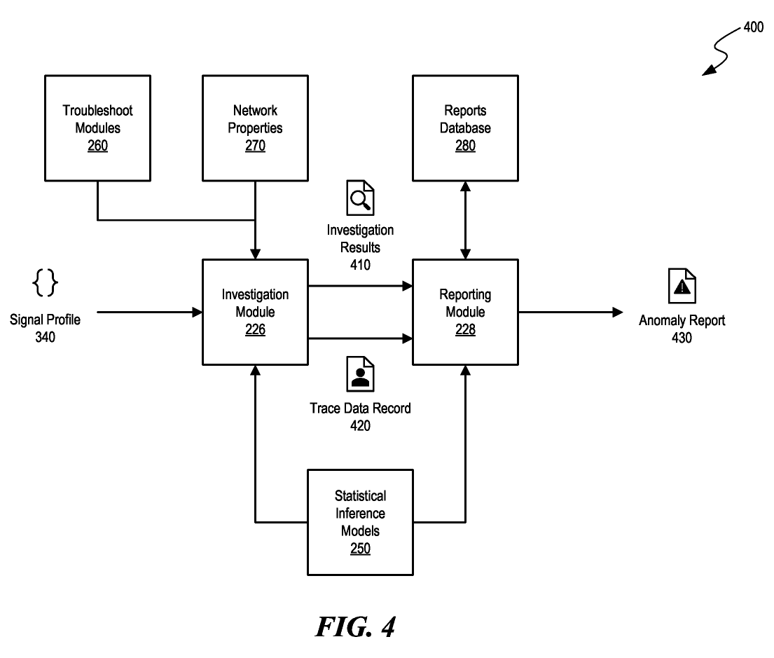

FIG. 4 is a block diagram that illustrates an example investigation process 400 of an anomaly management system, in accordance with some implementations of the present technology. The process 400 can be performed by a system (e.g., an anomaly management system 200) configured to deploy a troubleshoot agent (e.g., a self-executing software program) for evaluating compliance of network components with key performance indicators (KPIs). In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400. In alternative implementations, one or more processes described herein that are performed via a self-executing troubleshoot agent can instead be performed directly via the investigation module 226.

As shown in FIG. 4, the system comprises an investigation module 226 configured to deploy troubleshoot agents for identifying potential sources (e.g., erroneous network components) of anomalous signals. For example, the investigation module 226 can use a signal profile 340 of a detected anomalous signal 330 to generate a self-executing agent (e.g., an automated software program) configured to perform a set of troubleshoot operations (e.g., scanning for erroneous features, testing performance compliance, and/or the like) on network components of the telecommunications network. In particular, the investigation module 226 uses identified network attributes of the signal profile 340 to determine target network components (e.g., potential erroneous components) with relevance to a detected anomalous signal 330. As an example, the investigation module 226 can determine target network components for the anomalous signal 330 using mappings between network attributes and network components from stored network properties 270 of the telecommunications network.

Based on the target network components (e.g., and corresponding network properties 270), the investigation module 226 assigns one or more troubleshoot modules 260 for use by the self-executing agent. A troubleshoot module 260 is a modular executable program that, when invoked, performs investigative operations (e.g., scans, tests, and/or the like) that evaluate compliance of a network component (e.g., a node of the telecommunications network), and runtime operations thereof, to a set of KPIs (e.g., node performance thresholds). Accordingly, the investigation module 226 configures the self-executing agent to invoke (e.g., upon deployment) one or more troubleshoot modules 260 associated with the target network components. In further implementations, the investigation module 226 can configure the self-executing agent to invoke the assigned troubleshoot modules 260 in parallel (e.g., via multi-threaded execution).

In some implementations, the investigation module 226 can configure the self-executing agent to assess compliance of a target network component according to an evaluation rule set (e.g., from an assessment configuration file) that maps execution of individual troubleshoot modules 260 (e.g., unit test cases) to a compliance rating (e.g., pass/fail). For example, the investigation module 226 can configure the self-executing agent to store a positive compliance rating (e.g., pass) for the target network component when invocation of the corresponding troubleshoot module 260 generates evaluation results that exceed a specified KPI and/or network performance thresholds. In response to a negative compliance rating (e.g., fail), the investigation module 226 can configure the self-executing agent to apply statistical inference models 250 on the target network component to determine a set of erroneous features (e.g., anomalous execution patterns, erroneous source code, and/or the like) causing the negative compliance rating.

The investigation module 226 deploys a self-executing troubleshoot agent to generate investigation results 410 that evaluate compliance of target network components associated with an anomalous signal 330. For example, the investigation module 226 can generate (e.g., via self-executing troubleshoot agents) investigation results 410 of a target network component that comprises compliance ratings (e.g., pass/fail for specified KPIs) for each troubleshoot module 260 invoked by the self-executing agent. In some implementations, the investigation results 410 can further comprise identified erroneous features of the target network component (e.g., anomalous execution patterns, erroneous source code, and/or the like) that correspond to individual compliance ratings. In other implementations, the investigation results 410 can comprise a measured execution duration (e.g., elapsed completion time) of troubleshoot modules 260 corresponding to individual compliance ratings. In response to the measured execution duration of a troubleshoot module 260 exceeding (e.g., or falling below) a target duration (e.g., an expected execution time), the investigation module 226 can modify a set of KPIs and/or network performance thresholds to decrease (e.g., or increase) the evaluation sensitivity for investigative operations of the troubleshoot module 260.

In some implementations, the investigation module 226 can determine a trace data record 420 for a detected anomalous signal 330. For example, the investigation module 226 can assemble a composite data structure (e.g., a JSON object, a tabular CSV, and/or the like) comprising a set of identifiable metadata (e.g., a user profile, a packet data via PCAP reader, and/or the like) for target entities (e.g., network service users, dependent network components, and/or the like) impacted by target network components associated with the anomalous signal 330. In some implementations, the investigation module 226 can determine the trace data record 420 in parallel (e.g., via multi-threaded execution) with deployment, and performance, of the self-executing troubleshoot agent.

As shown in FIG. 4, the system comprises a reporting module 228 configured to generate an anomaly signal report 430 (“anomaly report 430”) for detected anomalous signals 330 of the telecommunications network. For example, the reporting module 228 creates a composite data structure (e.g., a JSON object, a tabular CSV, and/or the like) that comprises contents from investigation results 410 (e.g., generated via the investigation module 226) for an anomalous signal 330. In some implementations, the reporting module 228 can further incorporate (e.g., within the anomaly report 430) contents from trace data records 420 (e.g., generated via the investigation module 226) for the anomalous signal 330. Accordingly, the reporting module 228 can store the generated anomaly report 430 on a dedicated reports database 280 (e.g., a NoSQL/SQL database) of the computing database 204. In other implementations, the reporting module 228 can assign a unique report identifier (e.g., a set of searchable terms, an identification number, and/or the like) for the anomaly report 430. As a result, the reporting module 228 can use the stored report identifiers to filter for individual anomaly reports 430 that are similar and/or relevant to a new anomalous signal 330 and/or target network components. In additional or alternative implementations, the reporting module 228 can convert (e.g., via statistical inference models 250, natural language processing (NLP) algorithms, and/or the like) the anomaly report 430 data structure into an alphanumeric format (e.g., text string) that enables text-based filter functions (e.g., a search engine) to identify prior anomaly reports 430.

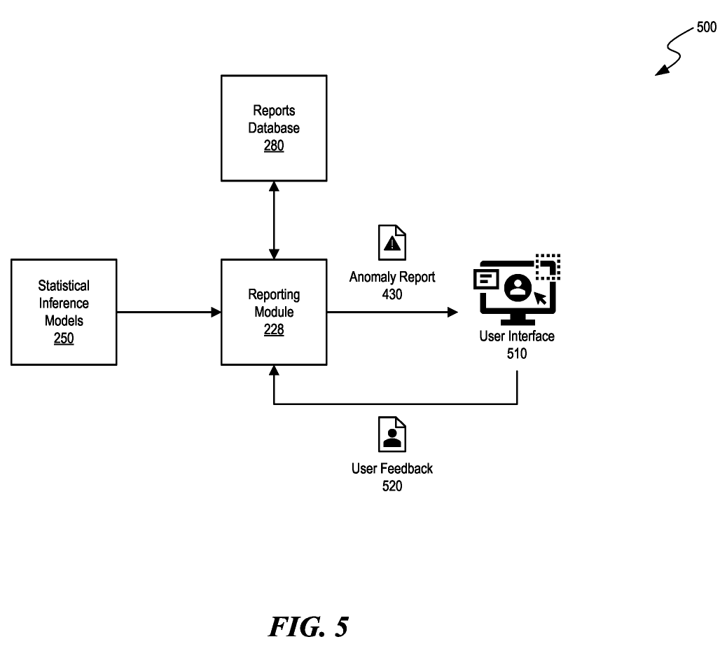

FIG. 5 is a block diagram that illustrates an example feedback process 500 of an anomaly management system, in accordance with some implementations of the present technology. The process 500 can be performed by a system (e.g., an anomaly management system 200) configured to incorporate received user feedback (e.g., from a user interface) to an anomaly signal report. In one example, the system includes at least one hardware processor and at least one non-transitory memory storing instructions, which, when executed by the at least one hardware processor, cause the system to perform the process 500. In another example, the system includes a non-transitory, computer-readable storage medium comprising instructions recorded thereon, which, when executed by at least one data processor, cause the system to perform the process 500.

As shown in FIG. 5, the system comprises a reporting module 228 configured to transmit an anomaly report 430 of a detected anomalous signal to a subscribing user (e.g., an authorized user, a network maintenance staff member, and/or the like). For example, the reporting module 228 can display contents of the anomaly report 430 at a custom interactable component (e.g., a dashboard, an anomaly analysis page, and/or the like) for a user interface 510 of the subscribing user. In another example, the reporting module 228 can directly transmit an alphanumeric version (e.g., text-based string) of the anomaly report 430 to the subscribing user via an established communication channel (e.g., a messaging application, an email address, and/or the like). In some implementations, the reporting module 228 can be configured to perform auxiliary operations to supplement the transmission of the anomaly report 430. For example, the reporting module 228 can send a notification alert (e.g., a priority message, a flagged email, a custom interface component, and/or the like) to the subscribing user alongside (e.g., simultaneously with) the anomaly report 430. In another example, the reporting module 228 can perform a search for prior anomaly reports 430 from the reports database 280 that are relevant (e.g., contain similar content) to the current anomaly report 430. Accordingly, the reporting module 228 can further transmit the identified prior anomaly reports 430 alongside (e.g., simultaneously with) the current anomaly report 430 to the subscribing user (e.g., at a custom interactable component of the user interface 510).

The reporting module 228 can be further configured to receive user-submitted feedback 520 (“user feedback 520”) for the presented anomaly report 430. For example, the reporting module 228 can receive, and store, user-submitted narratives (e.g., user input texts) for the anomaly report 430 via a custom interactable component of the user interface 510. In some implementations, the reporting module 228 can receive user-submitted narratives that comprise a description of remediation methods (e.g., instructions, update notes) used by the subscribing user to resolve, or partially resolve, the detected anomalous signal 330. In other implementations, the reporting module 228 can receive user-submitted narratives that comprise a timestamped log for user-initiated actions with respect to the anomaly report 430, such as opening the report, closing the report, saving the report, sharing the report, reviewing the report for an elapsed duration, searching for related reports, creating a new version of the report, and/or adding new narratives to the report. Accordingly, the reporting module 228 can use the contents of the user feedback 520 to generate a new version of the anomaly report 430 that is stored on the reports database 280.

In some implementations, the reporting module 228 can receive a request from the subscribing user (e.g., via the user interface 510) to search for prior anomaly reports 430 from the reports database 280. For example, the reporting module 228 can receive a user request comprising a set of search terms and/or filter options, such as an acceptable content similarity threshold between a prior anomaly report 430 and the presented anomaly report 430, for identifying a set of relevant prior anomaly reports 430. Accordingly, the reporting module 228 can display the identified set of anomaly reports 430 at the user interface 510 of the subscribing user.

In some implementations, the reporting module 228 can use statistical inference models 250 to facilitate and/or enhance interactive features between the subscribing user and the anomaly report 430. For example, the reporting module 228 can use a generative machine learning model (e.g., a large language model (LLM), an NLP model, and/or the like) to convert an alphanumeric format (e.g., text string) of the anomaly report 430 into a set of natural language (e.g., human-readable) messages. In another example, the reporting module 228 can apply a generative machine learning model onto the alphanumeric format of the anomaly report 430 to create a list of relevant subscribing users (e.g., assigned authorized users, network service developers) for the detected anomalous signal 330. Accordingly, the reporting module 228 can transmit the anomaly report 430 to each identified relevant subscribing user. In another example, the reporting module 228 can use a generative machine learning model to create a set of recommended remediation strategies for the subscribing user to resolve the anomalous signal 330 of the telecommunications network.

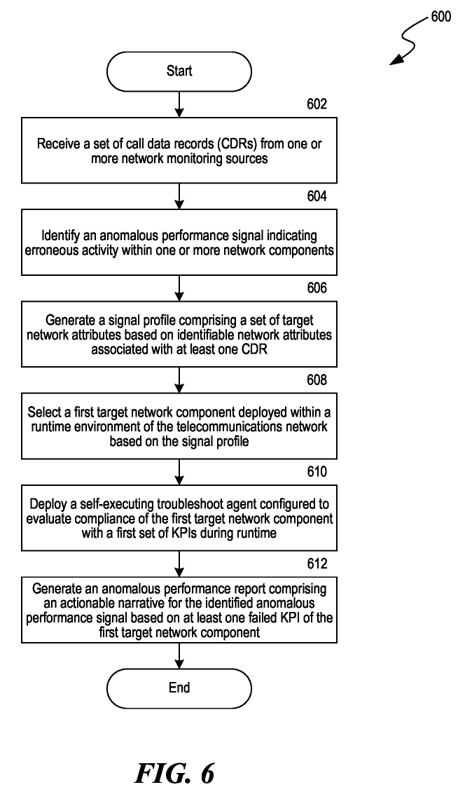

FIG. 6 is a flow diagram that illustrates a process 600 to evaluate anomalous performance signals in some implementations. The process 600 can be performed by a system (e.g., anomaly management system 200) configured to generate an anomalous performance report (e.g., an investigation analysis) indicating compliance of network components with one or more KPIs of a telecommunications network. In one example, the system includes at least one hardware processor and at least one non-transitory memory storing instructions, which, when executed by the at least one hardware processor, cause the system to perform the process 600. In another example, the system includes a non-transitory, computer-readable storage medium comprising instructions recorded thereon, which, when executed by at least one data processor, cause the system to perform the process 600.

At 602, the system can receive a set of call data records (CDRs) from one or more network monitoring sources. For example, the system can receive CDRs that each comprise real-time network traffic data and/or identifiable network attributes corresponding to one or more network components of a telecommunications network. The identifiable network attributes can comprise a cause code, a reason header, a market identifier, a Type Allocation Code (TAC), a region identifier, a pool identifier, a Telephony Application Server (TAS) node, a vendor identifier, a technology category, a Call Session Control Function (CSCF) node, a Mobile Terminated (MT) number analysis identifier, or a combination thereof.

In some implementations, the system can retrieve the set of CDRs from the one or more network monitoring sources when a specified duration since receiving a prior set of CDRs from the monitoring sources exceeds a periodic threshold. In other implementations, the system can retrieve a set of CDRs that comprises a first subset of CDRs corresponding to a first timestamp and a second subset of CDRs corresponding to a second timestamp different from the first timestamp such that the first and the second timestamps are within the specified duration since receiving the prior set of CDRs.

At 604, the system can identify an anomalous performance signal indicating erroneous activity within the one or more network components. For example, the system can use the real-time network traffic data of at least one CDR from the set of CDRs exceeding a tolerance threshold to identify the anomalous performance signal. In some implementations, the system can identify the anomalous performance signal by using a statistical inference model, such as a local outlier factor (LOF) model, to classify a portion of the real-time network traffic data of at least one CDR as outlier data.

At 606, the system can generate a signal profile for the identified anomalous performance signal. For example, the system can generate a signal profile that comprises a set of target network attributes based on the identifiable network attributes associated with the at least one CDR. In some implementations, the system can access a topological layout of two or more interconnected network components of the telecommunications network that comprises a set of identifiable network attributes shared between the two or more interconnected network components. In further implementations, the shared set of identifiable network attributes can comprise the set of target network attributes of the signal profile. Using the shared set of identifiable network attributes, the system can identify at least one identifiable network attribute that is excluded from the set of target network attributes. Accordingly, the system can add the at least one identifiable network attribute to the set of target network attributes of the signal profile.

At 608, the system can select a first target network component deployed within a runtime environment of the telecommunications network based on the signal profile. For example, the system can select a first target network component that comprises a first set of KPIs that, when satisfied, indicates acceptable component performance.

At 610, the system can deploy a self-executing troubleshoot agent configured to evaluate compliance of the first target network component with the first set of KPIs during runtime. In some implementations, the system can use a generative machine learning model to configure the self-executing troubleshoot agent. In some implementations, the system can receive, from the self-executing troubleshoot agent, an elapsed duration for evaluating compliance of the first target network component with the first set of KPIs of the first target network component. In further implementations, the system can automatically increase the periodic threshold based, at least in part, on the elapsed duration when the elapsed duration is above the periodic threshold. Likewise, the system can automatically decrease the periodic threshold based, at least in part, on the elapsed duration when the elapsed duration is below the periodic threshold.

At 612, the system can generate an anomalous performance report comprising an actionable narrative for the identified anomalous performance signal. In particular, the system can generate an anomalous performance report in response to the self-executing troubleshoot agent determining that the first target network component fails to satisfy at least one KPI from the first set of KPIs. For example, the system can generate the anomalous performance report based, at least in part, on the at least one failed KPI of the first target network component. Accordingly, the system can transmit the generated anomalous performance report for display at a subscribing user interface. In some implementations, the system can configure the actionable narrative for the identified anomalous performance signal to comprise at least one recommended remediation method for enabling the first target network component to satisfy the at least one failed KPI. In additional or alternative implementations, the system can generate the at least one recommended remediation method using a generative machine learning model.

In some implementations, the system can select a second target network component deployed within a runtime environment of the telecommunications network based on the signal profile. For example, the system can select a second target network component that comprises a second set of KPIs different from the first set of KPIs of the first target network component. Accordingly, the system can deploy a second self-executing troubleshoot agent configured (e.g., via generative machine learning model) to evaluate compliance of the second target network component with the second set of KPIs during runtime. In some implementations, the system can configure the deployed second self-executing agent to execute evaluation of the second target network component in parallel with the evaluation of the first target network component. In response to the second self-executing troubleshoot agent determining that the second target network component fails to satisfy at least one KPI from the second set of KPIs, the system can update the actionable narrative of the anomalous performance report based on the at least one failed KPI of the second target network component.

In other implementations, the system can retrieve a trace data record comprising a unique identifier for at least one user device connected to the telecommunications network that is impacted by the erroneous activity within the one or more network components. Accordingly, the system can update the actionable narrative of the anomalous performance report to include the unique identifier for the at least one impacted user device. In some implementations, the system can retrieve a trace data record in parallel with evaluation of the first target network component.

In some implementations, the system can receive (e.g., via the subscribing user interface) a user-specified target duration for evaluating compliance of the first target network component with the first set of KPIs. The system can also receive (e.g., via the self-executing troubleshoot agent) an elapsed duration for evaluating compliance of the first target network component with the first set of KPIs. As a result, the system can be configured to automatically update the periodic threshold to match the user-specified target duration when the elapsed duration is within the user-specified target duration.

In other implementations, the system can receive (e.g., via the subscribing user interface) a user feedback response to the anomalous performance report. For example, the system can receive a user feedback response that comprises a remediation method enabling the first target network component to satisfy the at least one failed KPI and/or an elapsed duration since initial user review of the anomalous performance report. Accordingly, the system can store (e.g., at a remote database) an updated version of the anomalous performance report such that the actionable narrative of the updated version comprises the remediation method from the user feedback response.

In some implementations, the system can access a set of prior anomalous performance reports stored at a remote database. For example, the system can access prior anomalous performance reports each comprising at least one recorded remediation method. Using the set of prior anomalous performance reports, the system can identify at least one prior anomalous performance report comprising a prior actionable narrative such that comparison (e.g., via a generative machine learning model) between the prior actionable narrative and the actionable narrative of the anomalous performance report exceeds a similarity threshold. Accordingly, the system can transmit the at least one recorded remediation method of the at least one prior anomalous performance report for display at the subscribing user interface.

In other implementations, the system can identify at least one user assigned to the first target network component based on the target network attributes of the signal profile. For example, the system can identify, using the target network attributes, at least one user that has authorized access to view the displayed anomalous performance report. Accordingly, the system can transmit a notification to the at least one user indicating required maintenance for the first target network component.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses large language models (LLMs).

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of an LLM may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

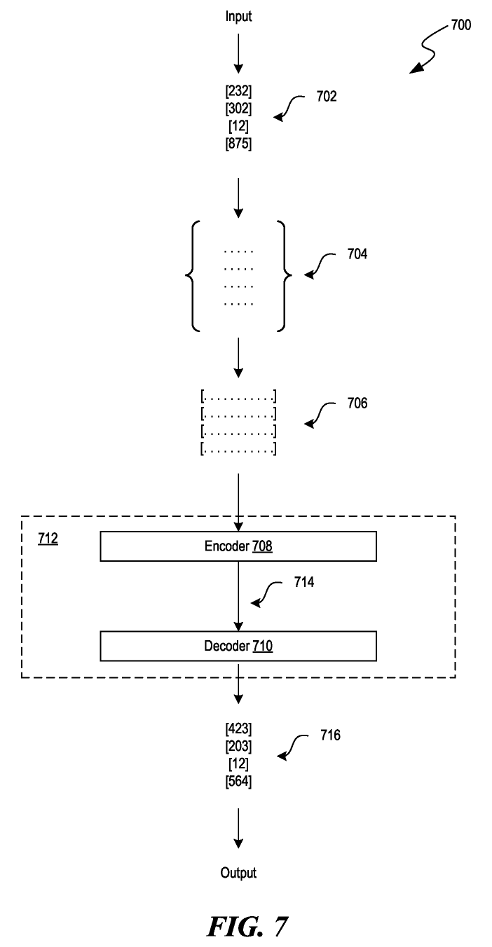

FIG. 7 is a block diagram of an example transformer 712 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 712 includes an encoder 708 (which can comprise one or more encoder layers/blocks connected in series) and a decoder 710 (which can comprise one or more decoder layers/blocks connected in series). Generally, the encoder 708 and the decoder 710 each include a plurality of neural network layers, at least one of which can be a self-attention layer. The parameters of the neural network layers can be referred to as the parameters of the language model.

The transformer 712 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 712 is trained to perform certain functions on other input formats than natural language input. For example, the input can include objects, images, audio content, or video content, or a combination thereof.

The transformer 712 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 7 illustrates an example of how the transformer 712 can process textual input data. Input to a language model (whether transformer-based or otherwise) typically is in the form of natural language that can be parsed into tokens. It should be appreciated that the term “token” in the context of language models and natural language processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], 1, and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 7, a short sequence of tokens 702 corresponding to the input text is illustrated as input to the transformer 712. Tokenization of the text sequence into the tokens 702 can be performed by some pre-processing tokenization module such as, for example, a byte-pair encoding tokenizer (the “pre” referring to the tokenization occurring prior to the processing of the tokenized input by the LLM), which is not shown in FIG. 7 for simplicity. In general, the token sequence that is inputted to the transformer 712 can be of any length up to a maximum length defined based on the dimensions of the transformer 712. Each token 702 in the token sequence is converted into an embedding vector 706 (also referred to simply as an embedding 706). An embedding 706 is a learned numerical representation (such as, for example, a vector) of a token that captures some semantic meaning of the text segment represented by the token 702. The embedding 706 represents the text segment corresponding to the token 702 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 706 corresponding to the “write” token will be closer to another embedding corresponding to the “jot down” token in the vector space as compared to the distance between the embedding 706 corresponding to the “write” token and another embedding corresponding to the “summary” token.

The vector space can be defined by the dimensions and values of the embedding vectors. Various techniques can be used to convert a token 702 to an embedding 706. For example, another trained ML model can be used to convert the token 702 into an embedding 706. In particular, another trained ML model can be used to convert the token 702 into an embedding 706 in a way that encodes additional information into the embedding 706 (e.g., a trained ML model can encode positional information about the position of the token 702 in the text sequence into the embedding 706). In some examples, the numerical value of the token 702 can be used to look up the corresponding embedding in an embedding matrix 704 (which can be learned during training of the transformer 712).

The generated embeddings 706 are input into the encoder 708. The encoder 708 serves to encode the embeddings 706 into feature vectors 714 that represent the latent features of the embeddings 706. The encoder 708 can encode positional information (i.e., information about the sequence of the input) in the feature vectors 714. The feature vectors 714 can have very high dimensionality (e.g., on the order of thousands or tens of thousands), with each element in a feature vector 714 corresponding to a respective feature. The numerical weight of each element in a feature vector 714 represents the importance of the corresponding feature. The space of all possible feature vectors 714 that can be generated by the encoder 708 can be referred to as the latent space or feature space.

Conceptually, the decoder 710 is designed to map the features represented by the feature vectors 714 into meaningful output, which can depend on the task that was assigned to the transformer 712. For example, if the transformer 712 is used for a translation task, the decoder 710 can map the feature vectors 714 into text output in a target language different from the language of the original tokens 702. Generally, in a generative language model, the decoder 710 serves to decode the feature vectors 714 into a sequence of tokens. The decoder 710 can generate output tokens 716 one by one. Each output token 716 can be fed back as input to the decoder 710 in order to generate the next output token 716. By feeding back the generated output and applying self-attention, the decoder 710 is able to generate a sequence of output tokens 716 that has sequential meaning (e.g., the resulting output text sequence is understandable as a sentence and obeys grammatical rules). The decoder 710 can generate output tokens 716 until a special [EOT] token (indicating the end of the text) is generated. The resulting sequence of output tokens 716 can then be converted to a text sequence in post-processing. For example, each output token 716 can be an integer number that corresponds to a vocabulary index. By looking up the text segment using the vocabulary index, the text segment corresponding to each output token 716 can be retrieved, the text segments can be concatenated together, and the final output text sequence can be obtained.

In some examples, the input provided to the transformer 712 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

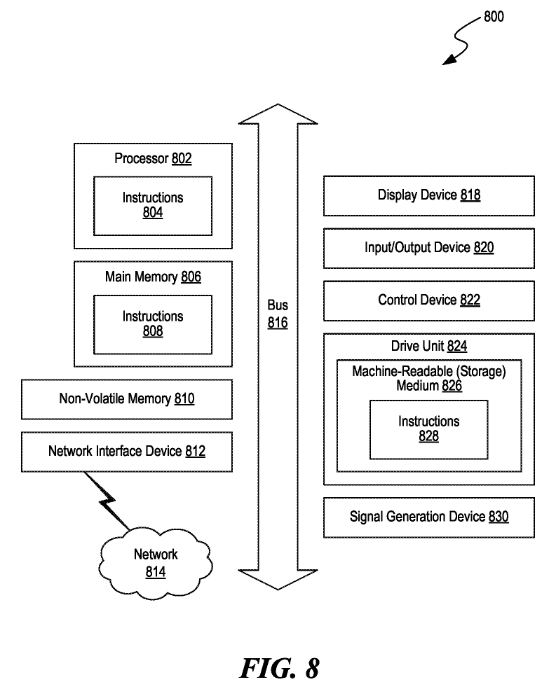

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method performed by an anomaly management system, the method comprising:
receiving a set of call data records (CDRs) from one or more network monitoring sources, each CDR comprising (i) real-time network traffic data and (ii) identifiable network attributes corresponding to one or more network components of a telecommunications network;
identifying, based on the real-time network traffic data of at least one CDR from the set of CDRs exceeding a tolerance threshold, an anomalous performance signal indicating erroneous activity within the one or more network components;
generating, for the identified anomalous performance signal, a signal profile comprising a set of target network attributes based on the identifiable network attributes associated with the at least one CDR;
selecting, based on the signal profile, a first target network component deployed within a runtime environment of the telecommunications network, the first target network component comprising a first set of key performance indicators (KPIs) that, when satisfied, indicates acceptable component performance;
deploying a self-executing troubleshoot agent configured, using a generative machine learning model, to evaluate compliance of the first target network component with the first set of KPIs during runtime;
responsive to the self-executing troubleshoot agent determining that the first target network component fails to satisfy at least one KPI from the first set of KPIs, generating an anomalous performance report comprising an actionable narrative for the identified anomalous performance signal based, at least in part, on the at least one failed KPI of the first target network component; and
transmitting the generated anomalous performance report for display at a subscribing user interface.

2. The computer-implemented method of claim 1 performed by the anomaly management system, the method further comprising:
selecting, based on the signal profile, a second target network component deployed within a runtime environment of the telecommunications network, the second target network component comprising a second set of KPIs different from the first set of KPIs of the first target network component;
deploying a second self-executing troubleshoot agent configured, using the generative machine learning model, to evaluate compliance of the second target network component with the second set of KPIs during runtime,
wherein evaluation of the second target network component is executed in parallel with evaluation of the first target network component; and
responsive to the second self-executing troubleshoot agent determining that the second target network component fails to satisfy at least one KPI from the second set of KPIs, updating the actionable narrative of the anomalous performance report based on the at least one failed KPI of the second target network component.

3. The computer-implemented method of claim 1 performed by the anomaly management system, the method further comprising:
retrieving a trace data record comprising a unique identifier for at least one user device connected to the telecommunications network that is impacted by the erroneous activity within the one or more network components,
wherein retrieval of the trace data record is executed in parallel with evaluation of the first target network component; and
updating the actionable narrative of the anomalous performance report to include the unique identifier for the at least one impacted user device.

4. The computer-implemented method of claim 1 performed by the anomaly management system, wherein retrieving the set of CDRs from the one or more network monitoring sources is performed when a duration since receiving a prior set of CDRs from the monitoring sources exceeds a periodic threshold.

5. The computer-implemented method of claim 4 performed by the anomaly management system,
wherein the retrieved set of CDRs comprises a first subset of CDRs corresponding to a first timestamp and a second subset of CDRs corresponding to a second timestamp different from the first timestamp, and
wherein the first and the second timestamps are within the duration since receiving the prior set of CDRs.

6. The computer-implemented method of claim 4 performed by the anomaly management system, the method further comprising:
receiving, from the self-executing troubleshoot agent, an elapsed duration for evaluating compliance of the first target network component with the first set of KPIs; and
when the elapsed duration is above the periodic threshold, automatically increasing the periodic threshold based, at least in part, on the elapsed duration.

7. The computer-implemented method of claim 6 performed by the anomaly management system, the method further comprising:
when the elapsed duration is below the periodic threshold, automatically decreasing the periodic threshold based, at least in part, on the elapsed duration.

8. The computer-implemented method of claim 4 performed by the anomaly management system, the method further comprising:
receiving, from the subscribing user interface, a user-specified target duration for evaluating compliance of the first target network component with the first set of KPIs;
receiving, from the self-executing troubleshoot agent, an elapsed duration for evaluating compliance of the first target network component with the first set of KPIs; and
when the elapsed duration is within the user-specified target duration, automatically updating the periodic threshold to match the user-specified target duration.

9. An anomaly management system comprising:
at least one hardware processor; and
at least one non-transitory memory storing instructions, which, when executed by the at least one hardware processor, cause the anomaly management system to:
receive a set of call data records (CDRs) from one or more network monitoring sources, each CDR comprising (i) real-time network traffic data and (ii) identifiable network attributes corresponding to one or more network components of a telecommunications network;
identify, based on the real-time network traffic data of at least one CDR from the set of CDRs exceeding a tolerance threshold, an anomalous performance signal indicating erroneous activity within the one or more network components;
generate, for the identified anomalous performance signal, a signal profile comprising a set of target network attributes based on the identifiable network attributes associated with the at least one CDR;
select, based on the signal profile, a first target network component deployed within a runtime environment of the telecommunications network, the first target network component comprising a first set of key performance indicators (KPIs) that, when satisfied, indicates acceptable component performance;
deploy a self-executing troubleshoot agent configured, using a generative machine learning model, to evaluate compliance of the first target network component with the first set of KPIs during runtime;
responsive to the self-executing troubleshoot agent determining that the first target network component fails to satisfy at least one KPI from the first set of KPIs, generate an anomalous performance report comprising an actionable narrative for the identified anomalous performance signal based, at least in part, on the at least one failed KPI of the first target network component; and
transmit the generated anomalous performance report for display at a subscribing user interface.

10. The anomaly management system of claim 9 further caused to:
select, based on the signal profile, a second target network component deployed within a runtime environment of the telecommunications network, the second target network component comprising a second set of KPIs different from the first set of KPIs of the first target network component;
deploy a second self-executing troubleshoot agent configured, using the generative machine learning model, to evaluate compliance of the second target network component with the second set of KPIs during runtime,
wherein evaluation of the second target network component is executed in parallel with evaluation of the first target network component; and
responsive to the second self-executing troubleshoot agent determining that the second target network component fails to satisfy at least one KPI from the second set of KPIs, update the actionable narrative of the anomalous performance report based on the at least one failed KPI of the second target network component.

11. The anomaly management system of claim 9 further caused to:
retrieve a trace data record comprising a unique identifier for at least one user device connected to the telecommunications network that is impacted by the erroneous activity within the one or more network components,
wherein retrieval of the trace data record is executed in parallel with evaluation of the first target network component; and
update the actionable narrative of the anomalous performance report to include the unique identifier for the at least one impacted user device.

12. The anomaly management system of claim 9 further caused to:
access a topological layout of two or more interconnected network components of the telecommunications network,
wherein the topological layout comprises a set of identifiable network attributes shared between the two or more interconnected network components, and
wherein the shared set of identifiable network attributes comprises the set of target network attributes of the signal profile;
identify, from the shared set of identifiable network attributes, at least one identifiable network attribute that is excluded from the set of target network attributes; and
add the at least one identifiable network attribute to the set of target network attributes of the signal profile.

13. The anomaly management system of claim 9, wherein the identifiable network attributes corresponding to the one or more network components of the telecommunications network comprise a cause code, a reason header, a market identifier, a Type Allocation Code (TAC), a region identifier, a pool identifier, a Telephony Application Server (TAS) node, a vendor identifier, a technology category, a Call Session Control Function (CSCF) node, a Mobile Terminated (MT) number analysis identifier, or any combination thereof.

14. The anomaly management system of claim 9, wherein identifying the anomalous performance signal comprises using a local outlier factor (LOF) model to classify a portion of the real-time network traffic data of at least one CDR as outlier data.

15. The anomaly management system of claim 9, wherein the actionable narrative for the identified anomalous performance signal comprises at least one recommended remediation method, generated using a generative machine learning model, for enabling the first target network component to satisfy the at least one failed KPI.

16. A non-transitory, computer-readable storage medium comprising instructions recorded thereon, wherein the instructions, when executed by at least one data processor of an anomaly management system, cause the anomaly management system to:
receive a set of call data records (CDRs) from one or more network monitoring sources, each CDR comprising (i) real-time network traffic data and (ii) identifiable network attributes corresponding to one or more network components of a telecommunications network;
identify, based on the real-time network traffic data of at least one CDR from the set of CDRs exceeding a tolerance threshold, an anomalous performance signal indicating erroneous activity within the one or more network components;
generate, for the identified anomalous performance signal, a signal profile comprising a set of target network attributes based on the identifiable network attributes associated with the at least one CDR;
select, based on the signal profile, a first target network component deployed within a runtime environment of the telecommunications network, the first target network component comprising a first set of key performance indicators (KPIs) that, when satisfied, indicates acceptable component performance;
deploy a self-executing troubleshoot agent configured, using a generative machine learning model, to evaluate compliance of the first target network component with the first set of KPIs during runtime;
responsive to the self-executing troubleshoot agent determining that the first target network component fails to satisfy at least one KPI from the first set of KPIs, generate an anomalous performance report comprising an actionable narrative for the identified anomalous performance signal based, at least in part, on the at least one failed KPI of the first target network component; and
transmit the generated anomalous performance report for display at a subscribing user interface.

17. The non-transitory, computer-readable storage medium of claim 16, wherein the instructions further cause the anomaly management system to:
select, based on the signal profile, a second target network component deployed within a runtime environment of the telecommunications network, the second target network component comprising a second set of KPIs different from the first set of KPIs of the first target network component;
deploy a second self-executing troubleshoot agent configured, using the generative machine learning model, to evaluate compliance of the second target network component with the second set of KPIs during runtime,
wherein evaluation of the second target network component is executed in parallel with evaluation of the first target network component; and
responsive to the second self-executing troubleshoot agent determining that the second target network component fails to satisfy at least one KPI from the second set of KPIs, update the actionable narrative of the anomalous performance report based on the at least one failed KPI of the second network component.

18. The non-transitory, computer-readable storage medium of claim 16, wherein the instructions further cause the anomaly management system to:
receive, from the subscribing user interface, a user feedback response to the anomalous performance report, the user feedback response comprising:
(i) a remediation method enabling the first target network component to satisfy the at least one failed KPI, and
(ii) an elapsed duration since initial user review of the anomalous performance report; and
store, at a remote database, an updated version of the anomalous performance report,
wherein the actionable narrative of the updated version comprises the remediation method from the user feedback response.

19. The non-transitory, computer-readable storage medium of claim 16, wherein the instructions further cause the anomaly management system to:
access a set of prior anomalous performance reports stored at a remote database, each prior anomalous performance report comprising at least one recorded remediation method;
identify, from the set of prior anomalous performance reports, at least one prior anomalous performance report comprising a prior actionable narrative,
wherein comparison, using a generative machine learning model, between the prior actionable narrative and the actionable narrative of the anomalous performance report exceeds a similarity threshold; and
transmit the at least one recorded remediation method of the at least one prior anomalous performance report for display at the subscribing user interface.

20. The non-transitory, computer-readable storage medium of claim 16, wherein the instructions further cause the anomaly management system to:
identify, based on the target network attributes of the signal profile, at least one user assigned to the first target network component,
wherein the at least one user has authorized access to view the displayed anomalous performance report; and
transmit a notification to the at least one user indicating required maintenance for the first target network component.
